(19) United States
(12) Patent Application Publication
(10) Pub. No.: US 2016/0169443 A1
(43) Pub. Date: Jun. 16, 2016

(54) Telescoping Tripod for Smartphones and Portable Media Players

(71) Applicant: Paul Andrew Keller, Eugene, OR (US)

(72) Inventor: Paul Andrew Keller, Eugene, OR (US)

(21) Appl. No.: 14/571,292

(22) Filed: Dec. 16, 2014

(51) Int. Cl. F16M 11/36; F16M 11/04; H04M 1/12; F16M 11/16

(52) U.S. Cl. CPC F16M 11/36; F16M 11/16; F16M 11/041; H04M 1/12

(57) ABSTRACT

A tripod with telescoping legs specific for supporting smartphones and portable media players of similar size and shape that have photographic and/or video capabilities is in the form of three telescoping legs that extend to reasonable adult eye level height and are attached to a support trough for holding the respective device being used. The support trough is lined by fabric to prevent scratching of the device, and a rubber coated wire arises from the outer side of the support trough to be brought over the device and bent at its edges to secure it in the desired position by the user. After the picture or video is taken, the rubber coated wire is unbent, the respective device removed, and the telescoping legs are collapsed down. This returns the tripod to its portable state, allowing it to be carried in a backpack or small bag.

### CROSS-REFERENCES TO RELATED APPLICATIONS

not applicable

### FEDERALLY SPONSORED RESEARCH AND DEVELOPMENT

not applicable

### SEQUENCE LISTING OR PROGRAM

not applicable

### SUMMARY OF THE INVENTION

It is the object of this present invention to provide a telescoping legs tripod specific for securing smartphones and portable media players of similar size and shape that reaches to reasonable adult eye level height without depending on other objects for elevation, and can be collapsed small enough to carry in a backpack or small bag.

### BACKGROUND OF THE INVENTION

1. Field of the Invention

Conventional adult eye level height tripods are primarily designed for traditional style cameras or more contemporary digital cameras that have threaded bolt mounting receptors on their bottoms for securing to the tripod. Considering that a rapidly growing portion of contemporary photos and videos are now taken by smartphones, and portable media players of similar size and shape such as the iPod Touch, there is a recognized need in the art for an improved tripod device. Also, there is an evident need in the fields of photography and videography that would allow the photographer or videographer to be included in the picture/video alone or with others, at a significant distance from the camera at the time the picture/video is taken so that the entire body or bodies can be seen with the surroundings. This is evident in photography when individuals ask other people, most often complete strangers, to take a picture of them alone or with others at locations of natural beauty, historical significance, restaurants, entertainment events, and special time points in their life to name just a few. This is also evident when different people in a group will take turns taking a picture, though this results in no picture where everybody is in a picture all together because somebody has to always be holding the camera. Another method of picture taking that displays the evidence for this need is when people reach out their devices as far as they can and take a, “selfie,” picture of themselves alone or with others because there may not be others available to assist, or they do not feel comfortable asking strangers for assistance, but this type of picture shows just the upper torsos and faces along with a very limited part of the surroundings.

The ability of smartphones and portable media players to utilize the camera self timer function, or easily download a self timer photo application, “app”, for just a few dollars to add this function, along with the present invention that is specific to securing these devices, will enable people to set the automatic timer on their device for the length of time of their choice, and then go be in the picture alone or with others and also capture their whole body or bodies and the surroundings. Recording videos can also be accomplished by the present invention and the video function that is now standard for smartphones and portable media players.

The advantages gained by this invention are that the support trough is designed specifically for securing smartphones and portable media players of similar size and shape, there is no need to connect to a threaded bolt mounting, photographers and videographers will be independent of having to ask others for help to take the picture or video, the picture or video can show the entire bodies of those in the picture with the surroundings, the display screen of the device is at reasonable adult eye level height and does require external support for elevation, and the collapsing nature of the telescoping legs allow the entire device to be compressed to 13.98 inches and carried in a backpack or small bag.

2. Description of the Related Art

Tripod support systems for cameras and video recorders are well known in the art. A tripod is a three-legged frame that supports a camera or video player and prevents movement of the device during the taking of a picture or video. Tripods have provided support from the earliest plate cameras through subsequent decades of transformations to contemporary digital cameras and digital video recorders. However, the use of conventional cameras or video recorders that have the sole function of taking photographs or videos respectively is rapidly changing to the general populace using smartphones and/or portable media players that can perform either one or both of these functions, as well as perform multiple other functions, all in a single device. This eliminates the need to carry multiple devices to perform these tasks. This significant shift in the types of devices to take photographs and videos has not, however, eliminated the need for a tripod, and in fact has led to more variations

U.S. Pat. No. 8,393,584, issued to Burns, discloses an apparatus for holding a portable electronic device comprising an attachment for holding the portable electronic device connected to a retractable neck. This neck is extended from a base and a suction cup attached to the base to be able to attach to surfaces compatible to suction cups.

U.S. Pat. No. 8,726,439, issued to Orzeck, discloses a multi tool with a handle arranged along a longitudinally aligned axis. The multi tool also has a prop which interoperates with the first handle and can be configured as a knife blade to be staked into the ground or other surface to provide stability against overturning of the device.

U.S. Pat. No. 7,624,955, issued to McGill discloses a support stand that includes a base and a mounting post that is collapsible into the base. This apparatus is very flat when the mounting post is collapsed into the base and not as bulky to carry as traditional tripods.

U.S. Pat. No. 8,733,712, issued to Xu discloses monopod comprised of an extendable mounting member with a first substantially tubular configuration and having a camera mounting assembly disposed thereon. This device allows the user to attach the photographic device to the monopod and utilize the length of the monopod plus that of the users arm, thereby obtaining more extended photographic views.

The inventions heretofore known for smartphones and portable media players are deficient in that they are short at full height and only raise a few inches to less than a few feet off the ground, requiring other external objects to hold them up to reasonable adult eye level height, such as a table, pole, window, automobile, or ledge. Also, these devices have threaded bolt mountings that require a female threaded receptacle at the bottom of the device to be attached. Most contemporary smartphones and portable media players of similar size and shape do not have a respective female threaded receptacle. The present invention fulfills these needs and desires in the art.

The present invention has been developed in response to the problem, not yet solved in the current state of the art, for a tripod specific to securing smartphones and portable media players, reaches to reasonable adult eye level height and can subsequently be collapsed small enough to carry in a backpack or small bag after using, does not require external objects for elevation, and does not require a threaded bolt mounting for securing to the tripod. Accordingly, the present invention has been developed to provide such a device that accommodates these needs.

### BRIEF DESCRIPTION OF THE DRAWINGS

In the accompanying drawings, like reference numbers refer to the same parts throughout all views.

FIG. 1 is a front side view showing the invention of a fully extended adult height tripod for smartphones and portable media players of similar size and shape.

FIG. 2 is a front side view with a smartphone or portable media player in the support trough and secured in placed by a bendable rubber coated wire.

FIG. 3 is a back side view of the invention with a smartphone or portable media player secured in the support trough.

FIG. 4 is right perspective view without the fabric liner in the support trough.

FIG. 5 is a top perspective view without the fabric liner in the support trough.

FIG. 6 is a top perspective view top of two felt cloth strips, that are directly over hex jam nuts, in support trough,

FIG. 7 is a top perspective view with fabric liner, that is directly over the two felt cloth strips, lining the entire support trough.

FIG. 8 is a right side view of the upper portion of the invention with a wide width smartphone or portable media player secured in the support trough.

FIG. 9 is a right side view of the upper portion of the invention with a narrow width smartphone or portable media player secured in the support trough.

FIG. 10 is a right side sectional view.

FIG. 11 is a front side view of the invention in the fully collapsed position.

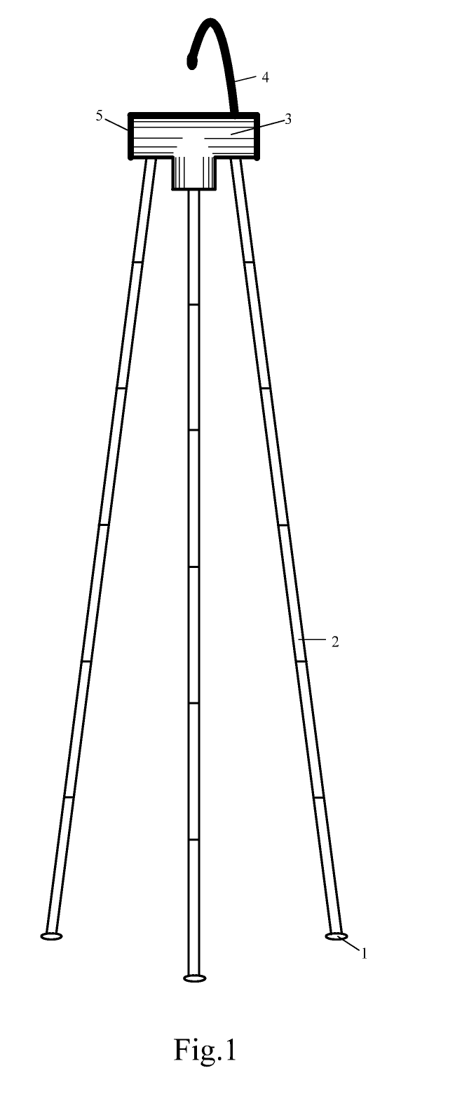

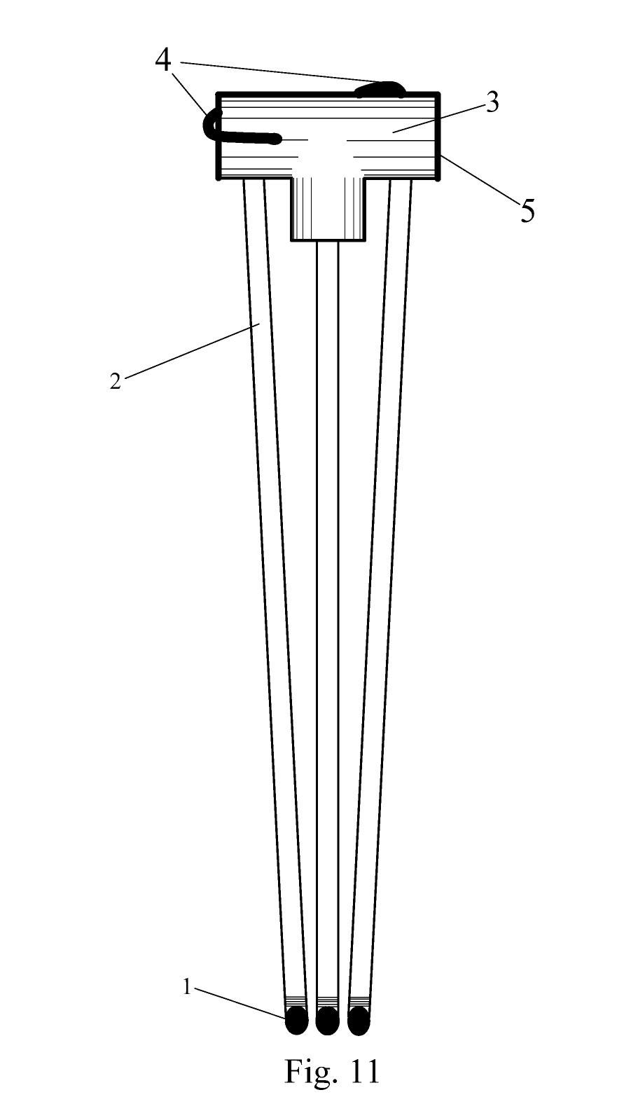

### INDEX OF ELEMENTS IN FIGS. 1-11

1—Rubber cap
2—Telescoping legs
3—Support trough
4—Rubber coated wire
5—Fabric lining
6—Hex jam nut
7—Threaded bolt
8—Smartphone or portable media player
9—Camera lens
10—Felt cloth strip

### DETAILED DESCRIPTION OF THE INVENTION

As used herein, the term “proximal” refers to a position closer to the support trough, and “distal” refers to a position further away from the support trough.

FIG. 1 is a front side view showing the invention of a fully extended adult height tripod specific for smartphones and portable media players of similar shape and size. The illustrated device includes three telescoping legs 2 that are covered by a rubber cap 1 at each respective distal end to prevent sliding of legs on ground when photograph or video is taken. Each telescoping leg collapses to 35 cm and can be manually extended to 168.2 cm (5 ft, 6 in) long when extended to full length.

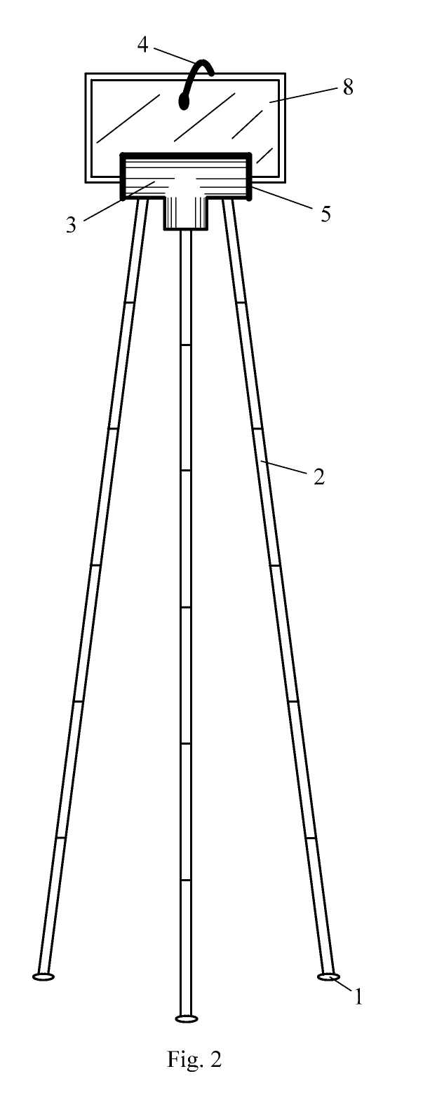

FIG. 2 is a front side view with a smartphone or portable media player 8 in the support trough 3 and secured in placed by a bendable rubber coated wire 4. The smartphone or portable media player screen faces the photographer or videographer so the user can frame the upcoming picture or video in the screen. If the user so desires at this time, the camera self timer can be set and initiated for various time amounts to allow this individual to go place themselves in the picture alone or with others. Recording a video also allows the user to be in the video as the user secures the device in the support trough, activates the record function, and then places self in the video if choosing to do so. The rubber coated wire is 13.97 cm long from its exit point at back of support trough, allowing it to amply be brought over the smartphone or portable media player and secure it in place with a quick pinch by the user. The rubber coated wire is easily bendable yet firm when positioned, allowing the photographer or videographer to take a picture or video in straight line of sight, or tilt the smartphone or portable media player either up or down to take a picture of the sky or ground respectively. The telescoping legs 2 can each be adjusted to multiple variations of length, allowing the tripod to stand at any height up to its fully extended position and accommodate significantly uneven terrain while maintaining the support trough in a horizontal position.

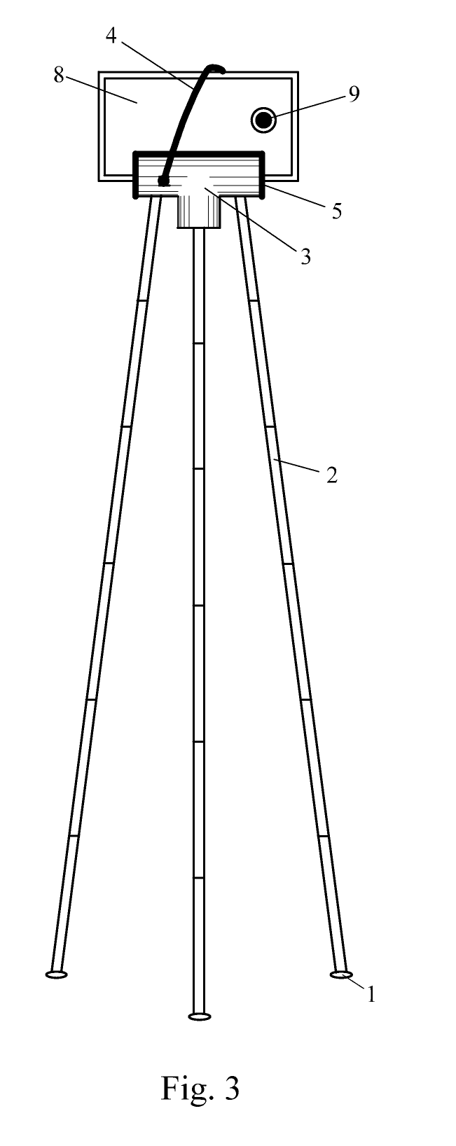

FIG. 3 is a back side view of the invention with a smartphone or portable media player 8 secured in the support trough 3 demonstrating how the rubber coated wire 4 can be manually adjusted to come over any part of the smartphone or portable media player and not cover the camera/video lens 9 of the respective device. One lens accommodates both photographs and videos for these devices.

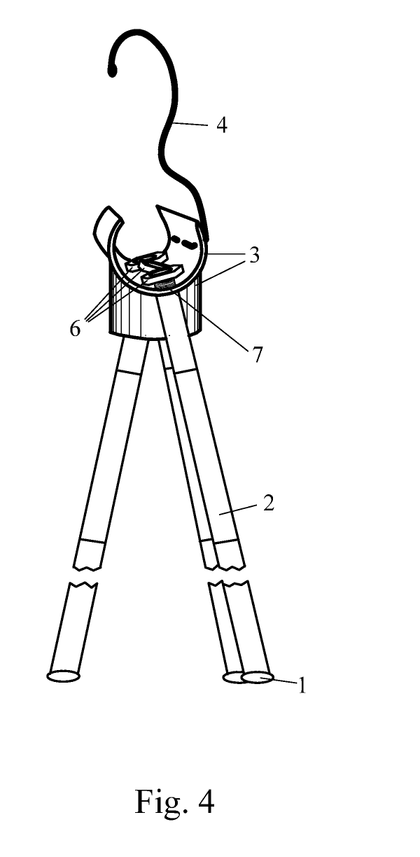

FIG. 4 is right perspective view without the fabric liner in the support trough 3. The affixed bolt 7 at the end of each telescoping leg 2 passes through the bottom of the support trough and is secured by a hex jam nut 6 in the base of the support trough. The diameter of each hole in the support trough is 0.2 cm wider than the diameter of the bolt, allowing each respective telescoping leg to be freely moved to stabilizing positions, which the standard in the state of this art is that the distal ends of the telescoping legs form a triangular shape on the ground. The support trough is made of PVC, but is could be envisioned that this component could be constructed of a variety of materials, such as but not limited to plastic, plastic composite, textiles, metal, metal alloys, etc, and combinations thereof and still perform its supporting task. Each hex jam nut is secured to the bolt with high strength thread locker adhesive that permanently secures the hex jam nut to its respective bolt to prevent loosening from the vibrations of normal use. Each hex jam nut is wider in width across than the respective hole at the bottom of the support trough, thus allowing the respective collapsed telescoping leg to be manually extended without being pulled out of the support trough.

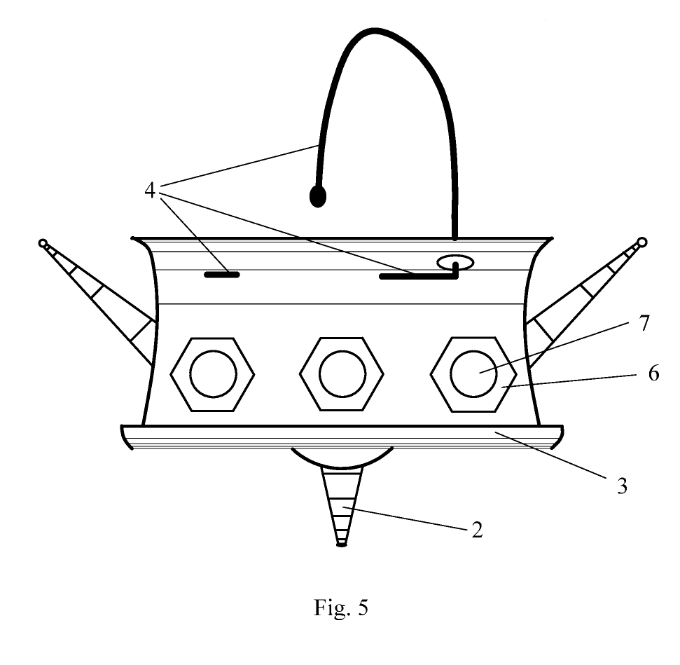

FIG. 5 is a top perspective view without the fabric lining in the support trough 3. In this view it can be seen that the rubber coated wire 4, which is secured via hot glue specifically designed to adhere PVC and rubber materials, passes through a hole in the back side of the support trough to enable it to be bent up and over the smartphone or portable media player by the user. Another piece of the rubber coated wire is also secured to the other end of the support trough so that the smartphone or portable media player does not tilt sideways from only having the slight bump under the fabric lining on one side.

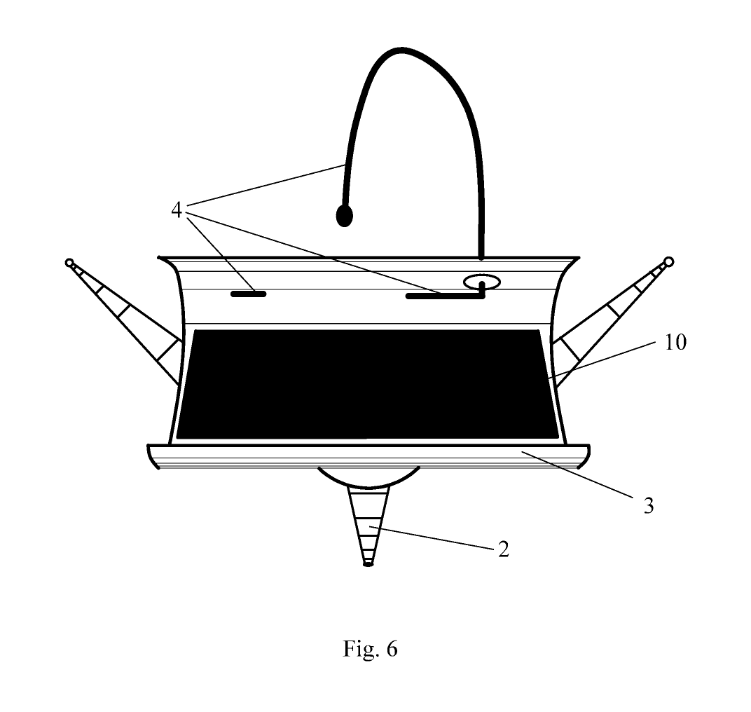

FIG. 6 is a top perspective view with fabric lining 5 in the support trough 3. The fabric lining is secured to the base of the support trough via hot glue specifically designed to adhere PVC and fabric. The fabric lining has two layers of felt cloth underneath it to provide an ample buffer between the smartphone or portable media player and the hex jam nuts below the fabric lining, enabling the hex jam nuts to move as the telescoping legs are positioned and not disturb the position of the smartphone or portable media player above.

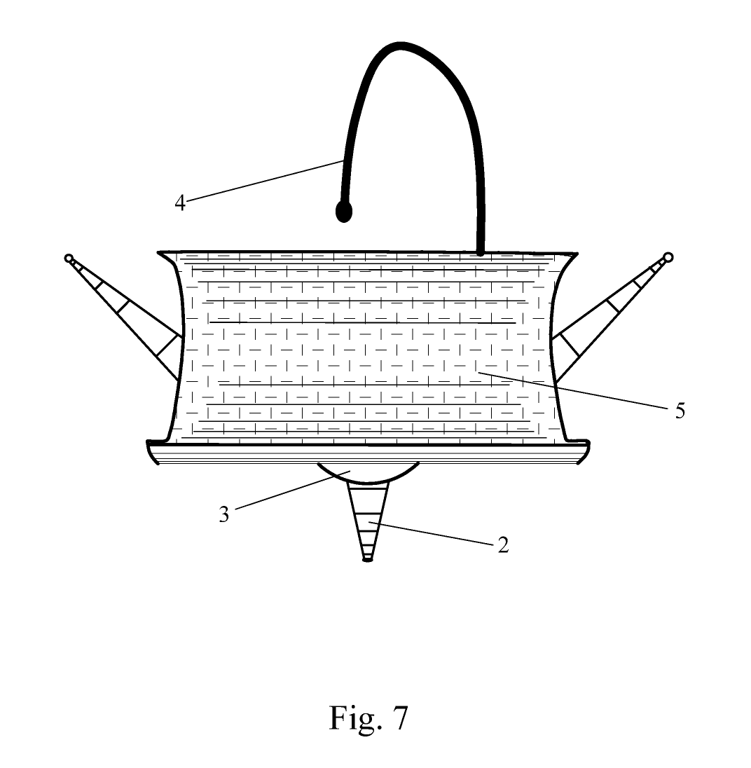

FIG. 7 is a right side view of the upper portion of the invention with a wide width smartphone or portable media player 8 secured in the support trough 3. The distance between top rims, including fabric lining 5, of the support trough is 1.5 cm, which accommodates contemporary smartphones and portable media players. This distance also accommodates the width of smartphones or portable media players in standard sized protective cases and covers, most of which include a hole for the camera lens in the respective case or cover. The smartphone or portable media player is secured in the support trough by bringing it bear up against the front side of the support trough, followed by the rubber coated wire 4 being manually brought up against the back of the device, up over the top, and partially down the front, being lightly pinched at both sides of the top of the device.

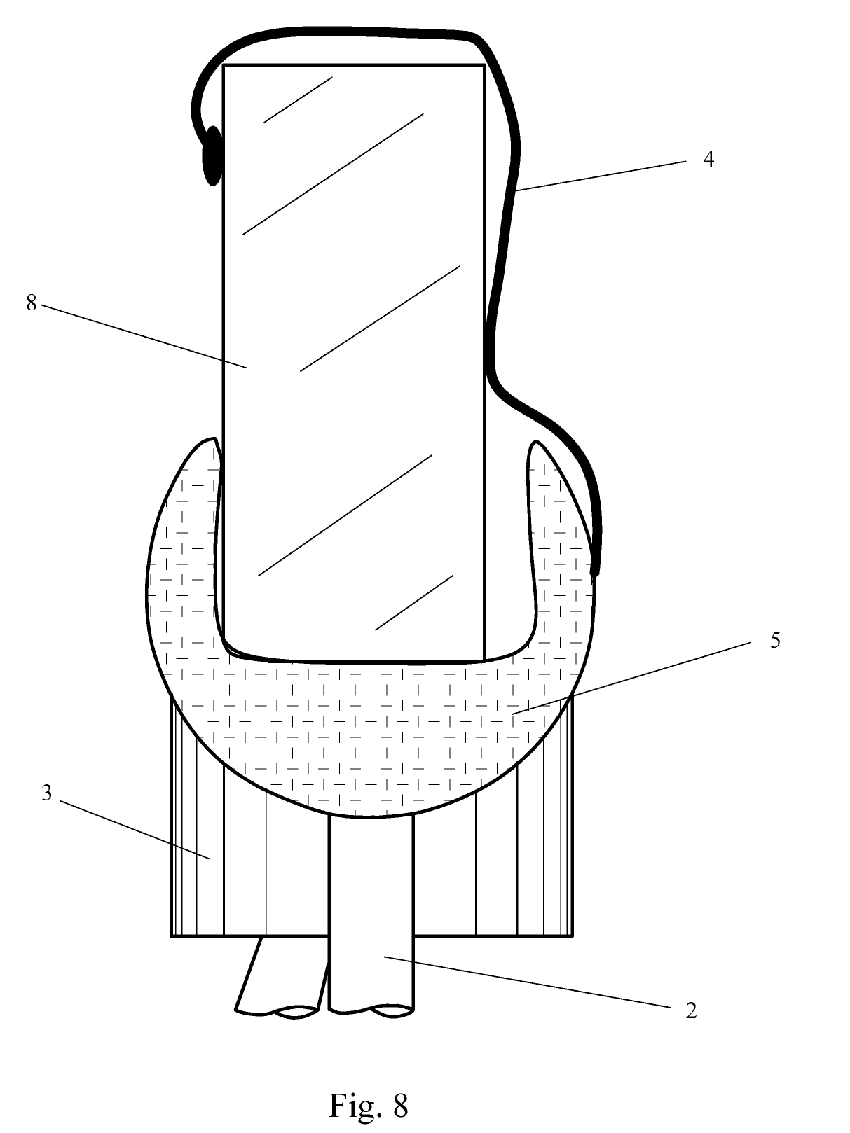

FIG. 8 is a right side view of the upper portion of the invention with a narrow width smartphone or portable media player 8 secured in the support trough 3. To accommodate the narrow width of these devices, this illustration demonstrates how the rubber coated wire 4 is brought forward further across the supporting trough before repeating the aforementioned procedure to secure the respective device.

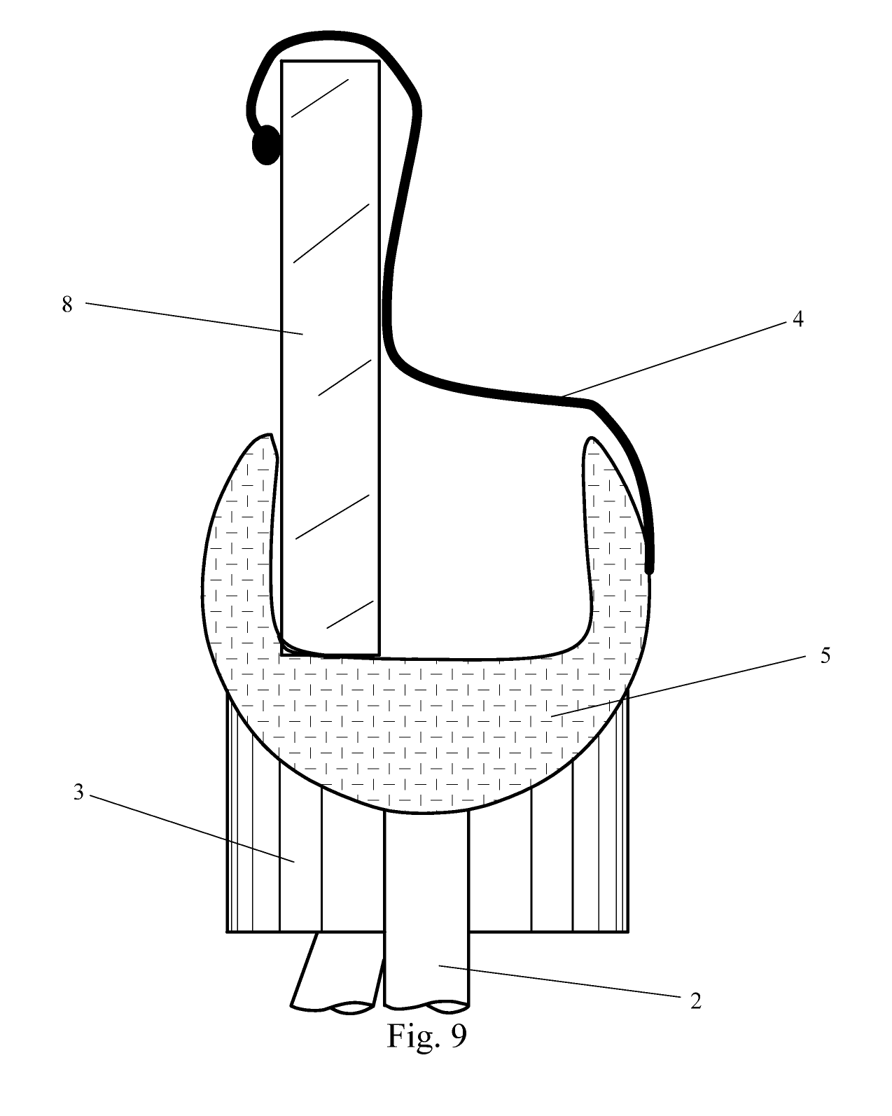

FIG. 9 is a front side view of the invention in the fully collapsed position. The length of the fully collapsed tripod from distal end of rubber cap 1 to top of support trough 3 is 35.5 cm (13.98 inches), allowing it to be carried in backpack or small bag.

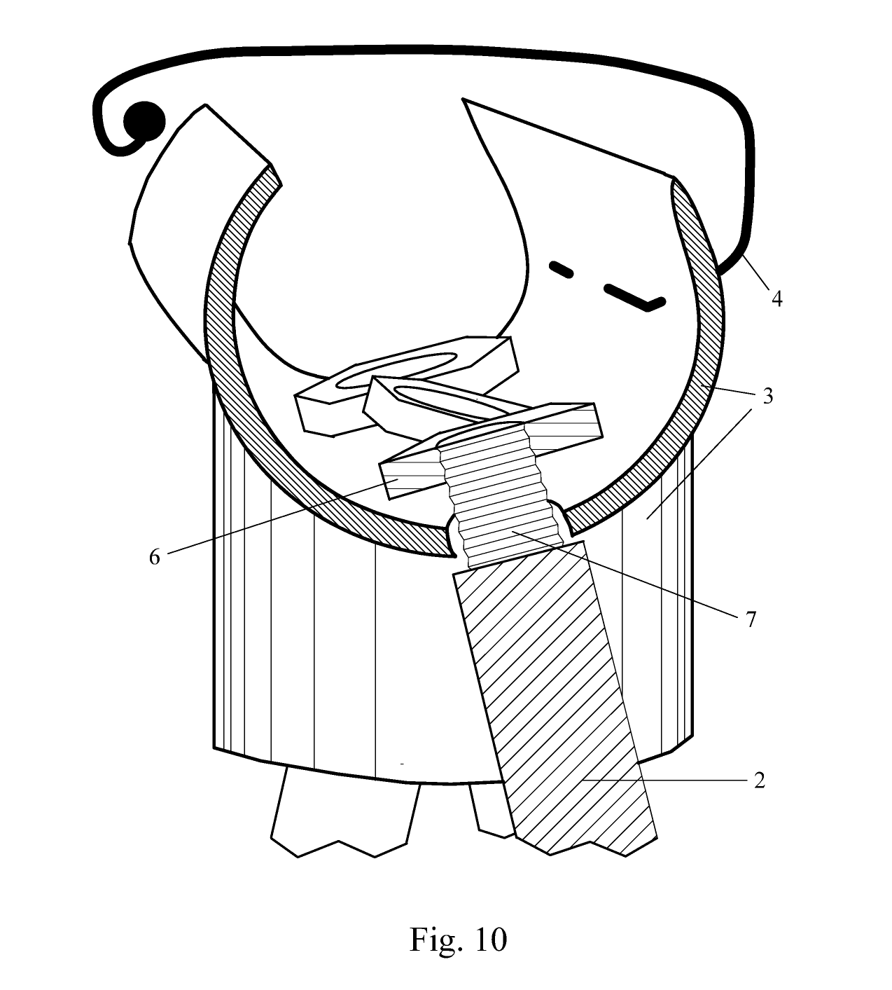

FIG. 10 is a right side sectional view illustrating how the hole in bottom of support trough 3 is larger than threaded bolt 7 to allow it to pass through and be attached to hex jam nut 6, but smaller than most proximal portion of most proximal telescoping leg 2 so that the telescoping legs are not pushed up into the support trough when manually collapsed. The hex jam nuts are secured at the top of the left and right threaded bolts, allowing enough free movement of their respective threaded bolts, and thus their respective telescoping legs to be positioned out to side up to 18 degrees from vertical and slightly forward, and the center hex nut jam is secured 0.2 cm from the top to allow it to be brought back up to 18 degrees, allowing the distal end of the telescoping legs to form a triangular shape on the ground to provide stability to the tripod. The telescoping legs cannot be moved further than 18 degrees as each respective hex jam nuts tilt and meets the solid and unmovable surface of the PVC material comprising the support trough.

What is claimed is:

1. A tripod specific for smartphones and portable media players comprising: three telescoping legs, a support trough, and a rubber coated wire to secure said smartphones or portable media players, wherein said support trough is attached to said telescoping legs and said rubber coated wire is attached to said support trough.

2. The said telescoping legs of claim 1, wherein the most distal point on each leg from the support trough is capped with a rubber cap to prevent sliding of said tripod on ground.

3. The said telescoping legs of claim 1, wherein each telescoping leg has six tubular members that are slidably disposed, the smallest circumference of said members at the most distal end and connected to increasingly larger circumferences of said members becoming more proximal to said support trough wherein each member slides in or out of the more proximal said member by a manual push or pull respectively.

4. The said telescoping legs of claim 1, wherein each said leg collapses to 33.5 cm and extends to 168.2 cm long when extended to full length, and the most proximal tubular member from said support trough wherein is attached to a 1.0 cm bolt which passes through a hole at the bottom of said support trough and is secured on the inside of said support trough by a hex jam nut and high strength thread locker adhesive between said 1.0 cm bolt and said hex jam nut to permanently secure them together.

5. The said support trough of claim 1, wherein three holes at the bottom of said support trough each accept a respective telescoping leg.

6. The said support trough of claim 1, wherein a hole on back side of said support trough accepts a short section of a longer rubber coated wire which passes through, is bent at ninety degrees, and affixed to the support trough via hot glue designed for adhering PVC and rubber, so that the longer length of the rubber coated wire on the outside of said support trough can be manually bent over a smartphone or portable media player in the said support trough to secure it in place until the picture or video respectively is taken and device removed thereafter by unbending the rubber coated wire.

7. The said support trough of claim 1, wherein a separate small length of rubber coated wire is affixed via hot glue designed for adhering PVC and rubber to inside of the support trough on other end of support trough from said rubber wire bent at ninety degrees to balance out the slight bump under fabric lining created by the rubber coated wire and keep said smartphone or portable media player from tilting sideways in the said support trough.

8. The said support trough of claim 1, wherein two strips of felt lay over the said hex jam nuts to provide an ample buffer between said smartphone or portable media player and said hex jam nuts, enabling the hex jam nuts to move as the telescoping legs are positioned and not disturb the position of the smartphone or portable media player above.

9. The said support trough of claim 1, wherein the said support trough is lined by fabric, thereby covering said two strips of felt cloth, said hex jam nuts, said rubber coated wires, and said PVC surface of said support trough, to prevent scratching of said smartphones or portable media players against these materials.
